(19) United States
(12) Patent Application Publication
(10) Pub. No.: US 2023/0325918 A1
(43) Pub. Date: Oct. 12, 2023

(54) Computer-Implemented Method for Visualising Features of a Trading Position

(71) Applicant: Brady Energy UK Limited, Edinburgh (GB)

(72) Inventors: Chris REGAN, LONDON (GB); Murray RENIE, LONDON (GB)

(21) Appl. No.: 17/705,191

(22) Filed: Mar. 25, 2022

(51) Int. Cl. G06Q 40/04

(52) U.S. Cl. CPC G06Q 40/04

(57) ABSTRACT

A computer-implemented method for visualising intermittency in a trading position for a portfolio of intermittent assets is disclosed comprising: determining a net open position for the portfolio; determining a target position to bring the net open position to zero based on a target degree of confidence in at least the forecasted energy generation; determining a higher position based on a higher degree of confidence in at least the forecasted energy generation; determining a lower position based on a lower degree of confidence in at least the forecasted energy generation; generating a position screen comprising a plot for one or more time periods, wherein the target position forms an axis of the plot, a first zone is indicated between the axis and the higher position and a second zone is indicated between the axis and the lower position; and indicating on the plot, the net open position.

### FIELD OF DISCLOSURE

The disclosure relates to a computer-implemented method for visualising features of a trading position.

### BACKGROUND

As a consequence of de-carbonisation and de-centralisation, energy generation from traditional large-scale power plants is gradually being replaced by that from renewable and other energy sources such as solar and wind power.

Similarly, traditional energy trading, based on a long-term outlook, is being transformed and there is a move to short-term (intra-day) energy trading. However, to date, entering the short-term energy trading market has required significant investment in systems, knowledge and infrastructure to manage real-time physical delivery. Legacy systems designed for coal and gas power generation are simply unsuitable to provide the required response times and therefore a new system for effectively managing short-term energy trading, and the associated energy output, is required.

The present disclosure therefore seeks to overcome shortcomings of the prior art systems and/or provide a useful alternative.

### SUMMARY

One or more aspects of the present disclosure relate to a computer-implemented method for visualising features of a trading position. More specifically, methods are described for illustrating, quickly and effectively, the impacts of uncertainty, optionality and price direction in relation to a trading position. Consequently, intra-day trading can be performed quickly and accurately.

In accordance with a first aspect of the disclosure there is provided a computer-implemented method for visualising intermittency in a trading position for a portfolio of intermittent assets in an energy market, the method comprising;
determining a net open position based on a difference between forecasted energy generation and forecasted energy sales for the portfolio for one or more time periods;
determining a target position to bring the net open position to zero based on a target degree of confidence in at least the forecasted energy generation;
determining a higher position to bring the net open position to zero based on a higher degree of confidence in at least the forecasted energy generation;
determining a lower position to bring the net open position to zero based on a lower degree of confidence in at least the forecasted energy generation;
generating a position screen comprising a plot for said one or more time periods, wherein the target position forms an axis of the plot, a first zone is indicated between the axis and the higher position and a second zone is indicated between the axis and the lower position; and
indicating on the plot, the net open position.

Embodiments of the first aspect of the disclosure therefore relate to a method for visualising, in the form of a graph (e.g. of time period versus net open position), the uncertainty of intermittent assets (i.e. assets you cannot directly control the energy generation from) and the effect of this on the net open position.

The net open position (NOP) represents what a trader needs to do to close out the position and become balanced. For example, if a trader has 100 MW of generation and 80 MW of sales then they will need to sell another 20 MW to become balanced. Conversely, if a trader has 90 MW of generation and 100 MW of sales then they will need to buy another 10 MW to become balanced. However, this simplified view does not take into account intermittency in the energy being generated. In other words, the amount of energy generated in a particular time period may not be certain and, consequently, the energy generation of each asset may be forecast with a level of uncertainty (i.e. variance) representing a possible range of energy that might be expected from an intermittent asset such as a wind or solar generation source. The trader may then choose to balance their NOP to a particular level of certainty within the forecasted range. Accordingly, the NOP may be illustrated with respect to not only an initial target position but also with respect to a higher position and a lower position, which together serve to define an intermittent balancing zone (IBZ).

The portfolio may include one or more assets, with each asset being capable of generating and supplying energy for sale on an exchange.

The position screen may comprise a plot for multiple consecutive time periods.

The one or more time periods may each have a duration of one market settlement period. For example, in the UK, the local market settlement period is 30 minutes. However, in other countries or markets the duration of one market settlement period may be different.

The first zone may be indicated on a first side of the axis and the second zone may be indicated on a second side of the axis.

The axis may be a horizontal x-axis, the first zone may be indicated in a negative domain of a vertical y-axis and the second zone may be indicated in a positive domain of the vertical y-axis.

The forecasted energy generation for the portfolio may comprise a sum of a forecasted energy generation for each intermittent asset including a variance in each forecast.

The forecasted energy generation for the portfolio may take into account a correlation of at least one asset to at least one other asset in the portfolio. For example, each intermittent asset within the portfolio may be correlated or uncorrelated with one or more other assets within the portfolio. Uncorrelated assets may be combined such that the variance in the combined output is the standard deviation of the sum of each variance. However, for correlated assets the variance in the combined output may simply be the sum of the variances of each asset. Accordingly, a portfolio of correlated and/or uncorrelated assets can be summed into a median output prediction with different levels of confidence using known statistical techniques.

The target degree of confidence may be calculated as a median output prediction, the higher degree of confidence may be calculated as at a higher than median confidence level, and the lower degree of confidence may be calculated at a lower than median confidence level.

The target degree of confidence may be calculated at a 50% confidence level, the higher degree of confidence may be calculated at a 75% confidence level, and the lower degree of confidence may be calculated at a 25% confidence level. Of course, these are only examples and other confidence levels could be selected (e.g. 10%, 50% and 90%).

The method may further comprise tracking outturn output for the portfolio and comparing the outturn output with the forecasted energy generation.

The method may further comprise determining whether any trends in variation between the outturn output and the forecasted energy generation indicate that the target position should be based on a different confidence level. The different confidence level may then be selected as the target position. The higher position and/or the lower position may also be updated.

The method may further comprise requesting user input for one or more of: the target degree of confidence; the higher degree of confidence; and the lower degree of confidence.

The method may further comprise refreshing the position screen to reflect a change in the net open position in real-time. For example, a change in the net open position may result from a trade and/or an update to the forecasted energy generation and/or the forecasted energy sales.

The trade or a price move may result in one of: an energy asset being turned on; an energy asset being turned up; an energy asset being turned off; or an energy asset being turned down. Thus, resulting in a change in the overall net open position of the trader.

The forecasted energy generation may take into account one or more of: asset capacity; renewables generation forecast; asset generation forecast; market price for energy generated; cost of generating energy.

The forecasted energy sales may take into account one or more of: time of day; time of week; time of year; renewables generation forecast.

The forecasted energy generation may be provided by one or more of: a battery; a wind turbine, a solar panel, a tidal generator or another energy source.

The method may further comprise one or more of: initiating a trade; completing a trade; and receiving confirmation of a trade once executed. Completing the trade may comprise placing an order on one or more exchange.

The method may further comprise updating the position screen to reflect the trade once executed. For example, the net open position may be balanced to the target position or to another position within the intermittent balancing zone.

In accordance with a second aspect of the disclosure there is provided a computer-implemented method for visualising optionality in a trading position for a portfolio of flexible assets in an energy market, the method comprising;
determining a net open position based on a difference between forecasted energy generation and forecasted energy sales for the portfolio for one or more time periods;
determining at least one longer net open position based on at least one increased price variance;
determining at least one shorter net open position based on at least one decreased price variance; and
generating a position screen comprising a plot indicating the net open position, the at least one shorter net open position and the at least one longer net open position.

Embodiments of the second aspect of the disclosure therefore relate to a method for visualising asset flexibility in the energy market and the effect of price variance on the net open position. For example, a trader may have flexible assets that can be switched on or off (or turned up or down) to generate more or less energy in response to energy price movement. Accordingly, if the price of energy rises, the trader may decide to produce more energy (e.g. by turning on an additional energy source) so as to sell more energy at the higher price and therefore generate more profit. The second aspect therefore helps a trader to visualise the effect of price changes on their net open position so that the trader can consider whether to close their position by trading energy (e.g. by buying more energy) or by adjusting the amount of energy produced from their existing assets (e.g. by self-supplying energy more cheaply from their portfolio).

The at least one shorter net open position and the at least one longer net open position may be illustrated by a stick length about the net open position. Such sticks may be referred to as gamma sticks or candlesticks.

The method may comprise:
determining at least two longer net open positions based on at least two increased price variances;
determining at least two shorter net open positions based on at least two decreased price variances; and
indicating on the plot the at least two shorter net open positions and the at least two longer net open positions.

The at least two shorter net open positions may be illustrated by at least two different coloured stick lengths extending from the net open position in a first direction; and the at least two longer net open positions may be illustrated by at least two different coloured stick lengths extending from the net open position in a second direction.

The method may further comprise refreshing the position screen to reflect a change in the net open position in real-time. For example, a change in the net open position may result from a trade and/or an update to the forecasted energy generation and/or the forecasted energy sales.

In accordance with a third aspect of the disclosure there is provided a computer-implemented method for visualising when to trade for a portfolio of intermittent assets in an energy market, the method comprising;
determining a net open position based on a difference between forecasted energy generation and forecasted energy sales for the portfolio for one or more time periods;
determining a direction of trade indicating whether buying or selling is required to balance the net open position;
obtaining a forecast price direction for the buying or selling based on current market analysis;
determining a timing recommendation for the buying or selling, based on the direction of trade and the forecast price direction; and
generating a position screen comprising a plot indicating the net open position, the direction of trade and the timing recommendation.

Embodiments of the first aspect of the disclosure therefore relate to a method for visualising when to trade based on a forecast price direction and this may be termed basis insight. For example, a trader might have a short position and a requirement to buy energy. However, if the insight expects prices to fall they should wait to buy energy more profitably at a later time. Conversely, if the insight expects prices to rise they should buy the required energy now before the price rises. Similarly, if a trader has a long position and a requirement to sell energy and the insight expects prices to fall they should sell the required energy now before the price falls. However, if the insight expects prices to rise they should wait to sell energy more profitably at a later time.

The direction of trade may be indicated by an arrow and the timing recommendation is indicated by a colour of the arrow.

The timing recommendation may comprise an indication to trade now or an indication to wait.

The determining the timing recommendation may comprise:
determining to trade now when either:
   the direction of trade is to buy and the forecast price direction is rising; or
   the direction of trade is to sell and the forecast price direction is falling; and
determining to wait when either:
   the direction of trade is to buy and the forecast price direction is falling; or
   the direction of trade is to sell and the forecast price direction is rising.

The method may further comprise refreshing the position screen to reflect a change in one or more of: the net open position, the direction of trade and the timing recommendation. For example, a change in the net open position and possibly also a change in the direction of trade may result from a trade and/or an update to the forecasted energy generation and/or the forecasted energy sales.

Any of the methods described above may further comprise any one or more of the other methods described above.

In accordance with a fourth aspect of the disclosure there is provided a non-transitory computer readable medium comprising instructions for carrying out any of the methods described above.

In accordance with a fifth aspect of the disclosure there is provided a computer system configured to carry out any of the methods described above.

These and other aspects will be apparent from the embodiments described in the following. The scope of the present disclosure is not intended to be limited by this summary nor to implementations that necessarily solve any or all of the disadvantages noted.

Any features described in relation to one aspect of the disclosure may be applied to any one or more other aspect of the disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Certain embodiments of the invention will now be described, by way of example only, with reference to the accompanying drawings, in which:

FIG. 1 shows a schematic representation of a trading system in accordance with an embodiment;

FIG. 2 shows a computer-implemented method visualising intermittency in a trading position for a portfolio of intermittent assets in an energy market, in accordance with an embodiment;

FIG. 3 shows an example screenshot showing an energy generation forecast graph;

FIG. 4A shows an example screenshot of a position screen showing net open position in the form of a graph in accordance with an embodiment;

FIG. 4B shows an enlarged portion of the screenshot of FIG. 4A, showing half-hour trading positions up to half hour 13, in accordance with an embodiment;

FIG. 4C shows an enlarged portion of the screenshot of FIG. 4A, showing the key for the position screen, in accordance with an embodiment;

FIG. 5 shows a computer-implemented method for visualising optionality in a trading position for a portfolio of flexible assets in an energy market, in accordance with an embodiment;

FIG. 6 shows a view similar to that of FIG. 4B, up to half hour 11, and with the intermittent balancing zones represented in different colours, in accordance with an embodiment;

FIG. 7 shows an example screenshot of an intraday price movement pop-up screen, in accordance with an embodiment;

FIG. 8 shows a computer-implemented method for visualising when to trade for a portfolio of intermittent assets in an energy market, in accordance with an embodiment;

FIG. 9 shows an enlarged portion of the screenshot of FIG. 6, showing a candlestick and positive basis insight, in accordance with an embodiment; and

FIG. 10 shows an enlarged portion of the screenshot of FIG. 4A, showing three candlesticks and a negative basis insight, in accordance with an embodiment.

### DETAILED DESCRIPTION OF CERTAIN EMBODIMENTS

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized, and that structural, logical, and electrical changes may be made without departing from the scope of the inventive subject matter. Such embodiments of the inventive subject matter may be referred to, individually and/or collectively, herein by the term ″invention″ merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims and their equivalents.

In the following embodiments, like components/steps are labelled with like reference numerals.

In the following embodiments, the term memory is intended to encompass any computer readable storage medium and/or device (or collection of data storage mediums and/or devices). Examples of memories include, but are not limited to, optical disks (e.g., CD-ROM, DVD-ROM, etc.), magnetic disks (e.g., hard disks, floppy disks, etc.), memory circuits (e.g., EEPROM, solid state drives, random-access memory (RAM), etc.), and the like.

As used herein, except wherein the context requires otherwise, the terms ″comprises″, ″includes″, ″has″ and grammatical variants of these terms, are not intended to be exhaustive. They are intended to allow for the possibility of further additives, components, integers or steps.

The functions or algorithms described herein are implemented in hardware, software or a combination of software and hardware in one or more embodiments. The software comprises computer executable instructions stored on computer readable carrier media such as a memory or other type of storage device. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, microcontroller or other type of processing device or combination thereof.

In a short-term power market the reasons to trade are typically very different from those in a longer term market. For example, a generating asset may have suffered a loss of output requiring the trader to buy back position; a wind forecast may have changed and the trader may wish to rebalance their NOP and avoid imbalance costs; or market prices may have moved through an asset’s cost (strike) price making it profitable to turn-on or turn-off the asset.

The purpose of a short-term trade is to lock in a known price (exchange bid or offer) in return for reducing (and for markets like the UK increasing) exposure to an unknown imbalance cost.

Given that volatility in energy generation is typically orders of magnitude higher than the bid/offer spread many trades are executed quickly at the lead bid or offer price and in the exact volume required to rebalance the trader’s position.

Once a trader has determined that they want to execute a trade they may wish to imitate a trade by placing an order on an exchange for the volume and price that they would be happy to trade at or aggress a trade by lifting someone else’s order to quickly close their position.

The aspects of the present disclosure allow the trader to visualise net open position, asset optimisation and market insight in a new and useful way. The methods described are each useful individually but may also be combined in one consolidated application or screen. More specifically, the aspects relate to visualising an Intermittent Balancing Zone (IBZ), Gamma Sticks and Basis Insight to inform the trader of how their net open position might evolve over time.

The methods of the present disclosure may use known statistical or trading strategy techniques to determine a target trading position for a portfolio of assets being balanced in the current (prompt) trading market period. Accordingly, forecasting, for example, in relation to energy generation, energy sales and market price direction may be determined using any suitable techniques, a variety of which are readily available to persons skilled in the art. As such, this information is obtained from any suitable sources and then fed into the methods disclosed as input parameters. Consequently, details of specific forecasting techniques are not disclosed herein.

The methods may use inputs from a system of records that track a trader’s or an organisation’s commitments and forecasts to determine the net open positions (NOP) from which a trader can trade. One potential system of records is an Enterprise Data Management (EDM) tool, such as one developed by the applicant. The EDM tool may provide time series data used by the disclosed methods to calculate the NOP from which to trade. The time series data may include asset specific information on a per time period basis covering, for example, Maximum Generation, Minimum Generation, Production Plan, also known as Physical Notification (PN), reserve and ancillary commitments. This data may be configured to flow from the EDM to a system operating any of the disclosed methods any time it is changed or updated, within a few seconds, to ensure the trader is provided with the most up to date view of their position.

Once the position is determined then a new bespoke way of summarising the data is employed to create a novel user experience, which may simultaneously present the impacts of uncertainty, optionality, and price direction into a live tradable visualisation.

Specific embodiments will now be described with reference to the drawings.

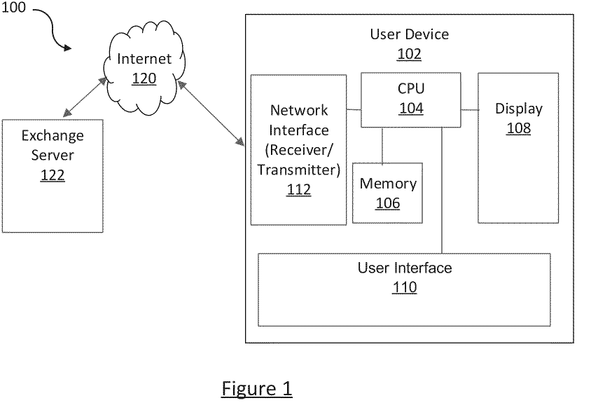

FIG. 1 illustrates a trading system 100 according to an embodiment of the invention. The system 100 comprises a user device 102, which may take the form of a personal computer (PC), laptop, tablet or the like. The user device 102 comprises a processor in the form of a central processing unit (CPU) 104, which is connected to a memory 106, a display 108, a user interface 110 and a network interface (receiver/transceiver) 112. The network interface 112 is configured to connect the user device (via a wired or wireless connection) to the internet 120. An exchange server 122 is also connected to the internet 120 and data and/or instructions may be transmitted in both directions between the user device 102 and the exchange server 122, via the internet 120.

The memory 106 may comprise a non-transitory computer readable medium comprising instructions for carrying out any of the methods described herein.

The display 108 may comprise a liquid crystal display, a light-emitting diode display or another display device.

In some embodiments, the user interface 110 may take the form of a touch screen and, in which, case, the user interface 110 may be integrated into the display 108. In other embodiments, the user interface 110 may comprise one or more of: a keyboard, a mouse, a tracker or a speech recognition device.

The network interface 112 may comprise a modem or cellular interface for connecting the user device 102 to the internet 120.

The exchange server 122 may comprise one or more processors and one or more memories for hosting an exchange. In practice, a plurality of user devices 102 will be connected to the exchange server 122 via the internet 120 to allow a plurality of users to trade on the exchange.

In some embodiments, one or more functions of the user device 102 may be carried out remotely. For example, one or more of the operations carried out by the CPU 104 and/or memory 106 may be performed via a cloud-based service, connected to the user device 102 via the network interface 112 and internet 120.

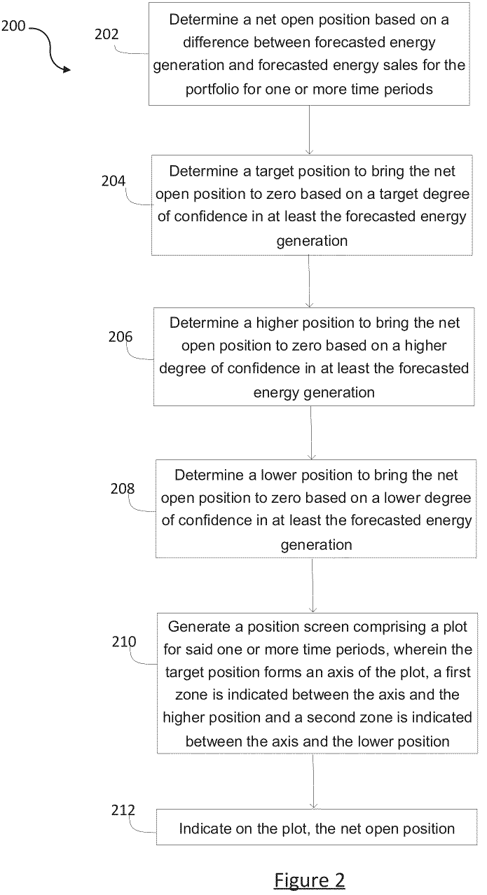

FIG. 2 shows a computer-implemented method 200 for visualising intermittency in a trading position for a portfolio of intermittent assets in an energy market in accordance with an embodiment. The method 200 comprises a first step 202 of determining a net open position based on a difference between forecasted energy generation and forecasted energy sales for the portfolio for one or more time periods. A next step 204 comprises determining a target position to bring the net open position to zero based on a target degree of confidence in at least the forecasted energy generation. A further step 206 comprises determining a higher position to bring the net open position to zero based on a higher degree of confidence in at least the forecasted energy generation. A subsequent step 208 comprises determining a lower position to bring the net open position to zero based on a lower degree of confidence in at least the forecasted energy generation. A step 210 then comprises generating a position screen comprising a plot for said one or more time periods, wherein the target position forms an axis of the plot, a first zone is indicated between the axis and the higher position and a second zone is indicated between the axis and the lower position. An additional step 212 comprises indicating on the plot, the net open position.

Accordingly, the method 200 allows the trader to view their net open position with respect to both a target and higher and lower positions so they can quickly and easily determine the degree of certainty they are trading to without having to rerun a process to trade to a different target position (i.e. a different degree of certainty in the forecasted energy generation).

It is important that the trader understands how much higher or lower the forecast generation or consumption might be. For directly controlled assets traders manage reliability — for example, a coal power station may be asked to generate 500 MW but it might only deliver 490 MW if the coal is wet or 0 MW if there is a boiler tube leak. ON the other hand, energy generation from renewable sources is intermittent and follows forecasts of generation rather than instructions. However, forecasts come with uncertainty and it is this uncertainty that the trader must try to maximise the value of.

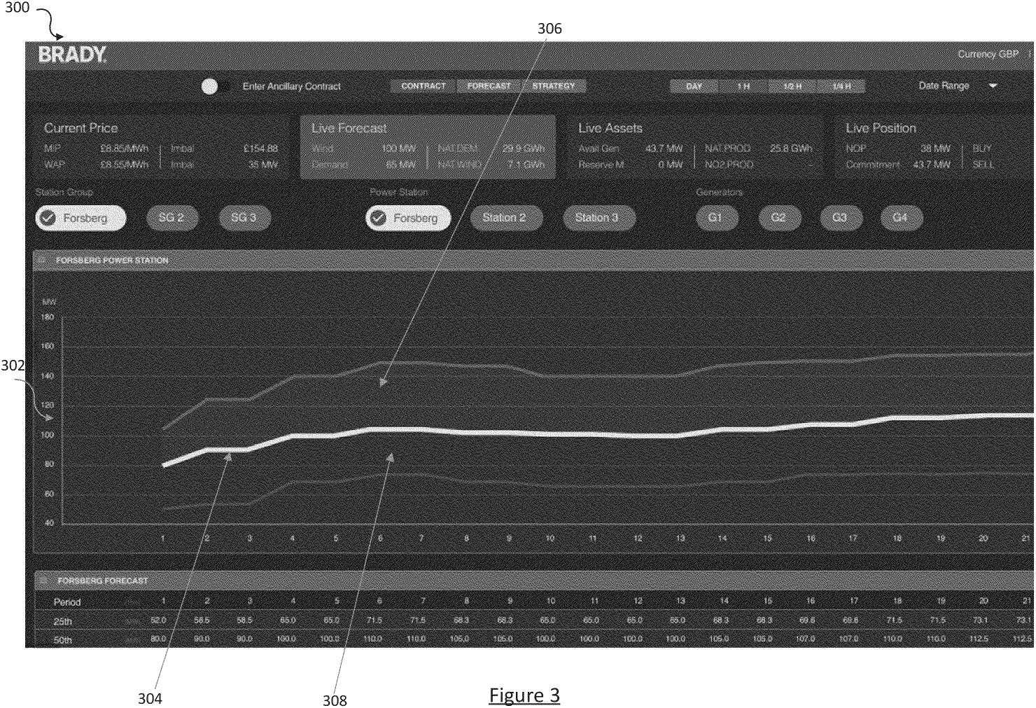

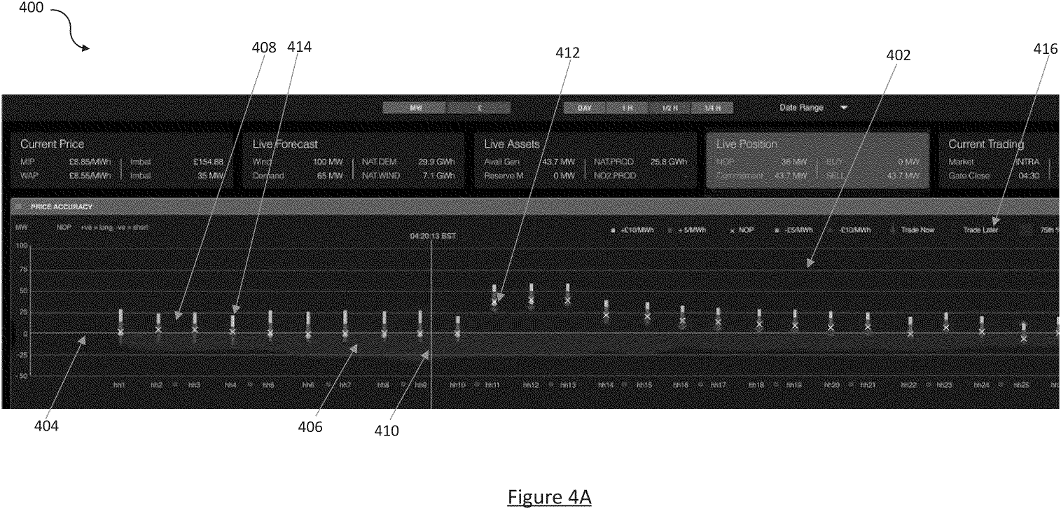

An example, of operation of the method 200 is described in more detail with respect to FIGS. 3 to 4C.

FIG. 3 shows an example screenshot 300 showing an energy generation forecast graph 302 having an x-axis showing the hours in a day and a y-axis showing the forecasted energy generation in MW. The expected generation is plotted in line 304, with uncertainty in the expected generation indicated by a green zone 306 for greater than expected generation and a red zone 308 representing lower than expected generation.

The graph 302 shows an energy generation forecast for a wind farm. The expected generation of line 304 typically represents 50% of the forecasted energy generation for the period concerned. A potential high out turn of between 50% and 75% of the forecasted energy generation for the period is indicated by the green zone 306. A potential low out turn of between 50% and 25% of the forecasted energy generation for the period is indicated by the red zone 308. In other cases, different percentages may be used for the expected generation and the potential high and low out turns, for example, based on a confidence level for the forecasted energy generation.

Typically, an energy generation forecast would be shown by plotting a point representing 50% of the forecasted energy generation for the period concerned and an error bar would be drawn vertically from the point to a user defined upper and lower confidence level (e.g. 25% to 75%). Similarly, the net open position would typically be shown by a point at the position resulting from the 50% generation forecast with an error bar drawn vertically from the point to the positions resulting from the user defined upper and lower confidence levels (e.g. 25% to 75%) for the generation forecast.

However, in the present method, the variance in possible performance of the intermittent assets is not shown as an error bar around the net open position. Instead, the present aspect of the disclosure reverses the way the uncertainty is viewed.

FIGS. 4A to 4C show an example screenshot of a position screen 400 showing net open position in the form of a graph 402, in accordance with the disclosure. As shown in FIG. 4A, the graph 402 comprises a horizontal x-axis 404 denoting 28 consecutive half-hour (hh) time periods and a y-axis denoting energy volume in MW (from -50 to +100). A vertical line 410 indicates the current time with respect to the x-axis 404.

In the graph 402, the net open position is balanced to zero (e.g. corresponding to 50% of generation forecast) on the x-axis 404 and the higher and lower variance (delta) in the uncertainty of the generation forecast is plotted inversely as a range around the x-axis. Accordingly, the higher confidence levels (e.g. between 50% and 75% of generation forecast) correspond to a green shaded area or zone 406 in the negative domain of the y-axis and the lower confidence levels (e.g. between 50% and 25% of generation forecast) correspond to a red shaded area or zone 408 in the positive domain of the y-axis. For example, if energy generation is forecast to be +20MW at the 75^{th} percentile, this is represented on the graph 402 by the lower green zone 406 extending to -20 MW (i.e. y=-20). Conversely, if energy generation is forecast to be -25 MW at the 25^{th} percentile, this is represented on the graph 402 by the upper red zone 408 extending to +25 MW (i.e. y=+25).

As shown clearly in FIG. 4B, an open position 412 is plotted at HH11 above the upper green zone 408. This indicates that the trader’s net open position is short (i.e. they are have a volumetric shortfall) in HH11 as the forecast energy generation is less than 25%. This may occur, for example, when a new forecast is received indicating that the forecasted energy generation is going to be less than previously expected in that period. To address this situation, the user can opt to trade the volume (Quantity of energy) required to bring the net open position for HH11 to zero by placing a suitable order (in this case a buy order) on the exchange.

Although the example described above relates to an out of balance position wherein the trader is short (i.e. the forecasted energy generation is lower than the forecasted (existing) energy sales in connection with the portfolio of assets for the period concerned), the example could equally relate to an out of balance position wherein the trader is long (i.e. the forecasted energy generation is greater than the forecasted (existing) energy sales in connection with the portfolio of assets for the period concerned). In either case, the method disclosed can be used to determine the volume required to buy or sell to bring the net open position back into balance.

The trader’s calculated net open position is plotted by an x on the graph 402. Accordingly, if the calculated net open position x is lying close to the top of the red zone 408, the trader will quickly be able to realise that although the position is ″short″ (underage) versus the target position (50% generation) forecast they are actually balanced to the 25^{th} percentile. Similarly, a trader having a position that is ″long″ (overage) and in the green zone 406 actually means they are balanced between the 50% and the 75^{th} percentile. Accordingly, the red zone 408 and the green zone 406 represent, respectively, upwards and downwards (short or long) intermittent balancing zones or regions. The graph 402 is advantageous over other graphs because the variance or opportunity of the forecast can be expressed about the target position (i.e. x-axis) whilst still having a zone to balance within.

In FIGS. 4A and 4B each net open position x is provided with a candlestick 414 illustrating the effect of price variance on the net open position as will be explained in more detail below.

It should be noted that in the example illustrated, the net open position is based around a target position of the 50^{th} percentile of the sum of the forecasts for the assets concerned but could be based on a different target percentile (and/or different upper and lower percentiles) depending on the trader’s confidence in the energy generation forecasts for the portfolio.

By exploiting asymmetries in volume and price risk the trader can ensure that shortfalls are not too costly and oversupply is not provided at too cheap a price. A number of strategies are possible when balancing intermittency. For example, using a volumetric best estimate approach the trader can simply try to balance to the 50^{th} percentile of the energy generation forecast. However, using a volumetric approach with short-term trending the trader can typically balance to the 50^{th} percentile but can deviate between the 25^{th} and 75^{th} percentiles when they observe out turn trending in a particular direction. Furthermore, with a value maximising approach, the trader may use a combination of the volume (generation) variance and asymmetry of price risk to determine a suitable bias away from the 50^{th} percentile. A strategy may follow that similar to that of the known ″newsvendor’s dilemma″ whereby a model is used to determine an optimal inventory level for a perishable product having a fixed price and uncertain demand since too low an inventory would result in lost sales and too high an inventory would result in worthless over-production.

In the present case, the trader can execute orders knowing the underlying variance of the whole portfolio and can see the live costs of underage and overage in order to determine a profit maximising strategy.

In the method of the present disclosure, the user can determine what percentiles they want shown on the open position graph 402 either as a target position for the x-axis 404 or as higher or lower positions defining uncertainty areas 406, 408 around the x-axis 404. For example, a trader would be balancing to 0 megawatts (MW) if they had 100 MWs of generation and 100 MW of sales. However, if the 100 MW of generation (at a target 50^{th} percentile) was 110 MW at the 60^{th} percentile the trader could balance to minus 10 MWs (with respect to the target position) but be balanced at the 60^{th} percentile. Accordingly, the trader has the ability to trade down to a long position, which is actually balanced against a higher confidence level.

In some examples, the sum of energy generation forecasts and variances from all intermittent assets in the portfolio may be used to determine exactly how much energy to trade to close the trader’s overall net open position. For example, one wind farm may be expected to generate 100 megawatts at the 50^{th} percentile but it might only generate 80 megawatts at the 25th percentile confidence interval and 120 megawatts at the 75th percentile and another wind farm may be expected to generate 80 megawatts at the 50^{th} percentile but it might only generate 70 megawatts at the 25th percentile confidence interval and 90 megawatts at the 75th percentile. By combining the energy generation forecasts and variances from each asset it is possible to determine the overall probable generation or consumption at different levels of confidence.

Each intermittent asset within the portfolio may be correlated or uncorrelated with one or more other assets within the portfolio. For example, if a wind farm with a forecast of 100 MW and a standard deviation of 10 MW is added to another uncorrelated wind farm of 100 MW with a standard deviation of 10 MW then the total output would be 200 MW with a standard deviation of Sqrt(10²+10²) = 14.14 MW. However, if the two wind farms were 100% correlated then the output would be 200 MW with a standard deviation of 20 MW. Accordingly, a portfolio of correlated and/or uncorrelated assets can be summed into a median output prediction with different levels of confidence using known statistical techniques.

By tracking the outturn output compared to the forecast output at the user selected confidence levels (e.g. 25^{th}, 50^{th}, 75^{th} etc.) the trader can determine whether any short-term trends are leading to a consistent error between the forecast generation and the outturn. If a systematic bias is observed a trader can opt trade to a different confidence interval.

As best shown in FIG. 4C, the graph 402 is provided with a key 416. The key 416 confirms that, in the present example, the confidence level for the upper boundary of the red zone 408 is 25% and the confidence level for the lower boundary of the green zone 406 is 75%. In addition, the key indicates the price variances (+£10/MWh, +£5/MWh, -£5/MWh and -£10/MWh) that are illustrated in the candlesticks 414 about the net open position (NOP) x. Lastly, the key indicates that the colour of an arrow 418 (see FIG. 4B), which may also be illustrated on the candlesticks 414, indicates whether the trader should trade now (green) or trade later (red) as will be explained in more detail below.

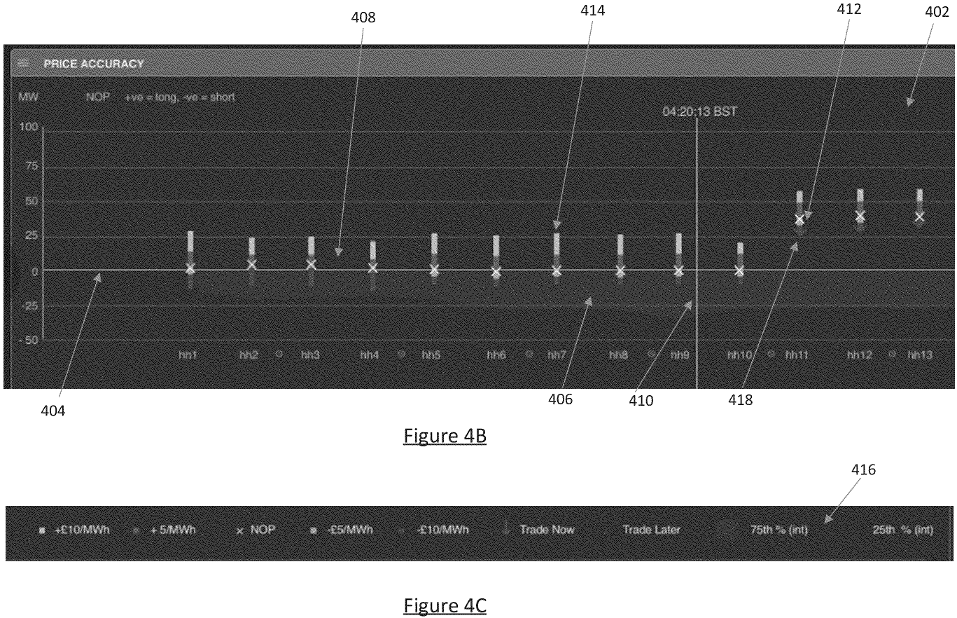

FIG. 5 shows a computer-implemented method 500 for visualising optionality in a trading position for a portfolio of flexible assets in an energy market, in accordance with an embodiment. The method 500 comprises a step 502 of determining a net open position based on a difference between forecasted energy generation and forecasted energy sales for the portfolio for one or more time periods. A step 504 comprises determining at least one longer net open position based on at least one increased price variance and a step 506 comprises determining at least one shorter net open position based on at least one decreased price variance. A step 506 comprises generating a position screen comprising a plot indicating the net open position, the at least one shorter net open position and the at least one longer net open position.

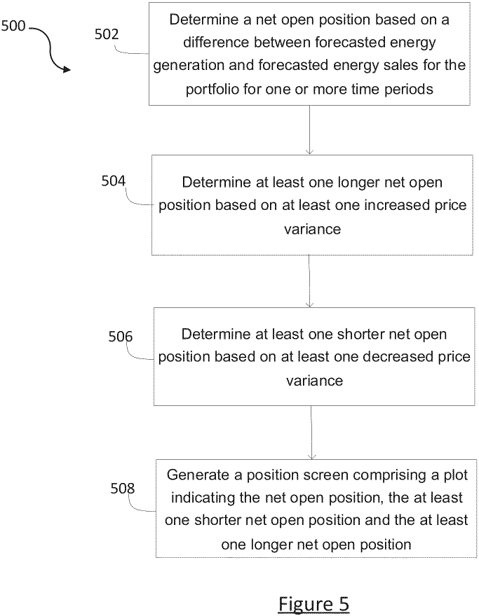

FIG. 6 shows a graph 600 that is similar to that of FIG. 4B, up to half hour 11, and with the intermittent balancing zones represented in different colours, in accordance with an embodiment. The graph 600 plots the net open position x for consecutive half hour periods. In this case, the net open position x is balanced to zero (e.g. corresponding to 50% of generation forecast) on the x-axis 404 and the higher and lower variance (delta) in the uncertainty of the generation forecast is plotted as a range around the x-axis. Accordingly, the higher confidence levels (e.g. representing a short position for between 50% and 75% of generation forecast) correspond to a green shaded area or zone 606 in the negative domain of the y-axis and the lower confidence levels (e.g. representing a long position for between 50% and 25% of generation forecast) correspond to a red shaded area or zone 608 in the positive domain of the y-axis. As mentioned previously, candlesticks 404, which illustrate the effect of price variances (+£10/MWh, +£5/MWh, -£5/MWh and -£10/MWh) as detailed in the key of FIG. 4C, are shown about each net open position (NOP) x.

Net open position reports are typically volumetric and market price movements could mean that balancing by changing the volume of energy produced from assets in the trader’s portfolio might be more cost-effective than trading when there is a wide bid offer spread or the market gaps. It is therefore important that the trader understand the optionality that their portfolio offers given the current status of assets and price. Historically, with large fixed assets the trader would know their strike prices and manage market liquidity accordingly. However, with a portfolio of micro assets and variable strikes this is not possible and the portfolio generation must be optimised every time prices move.

A portfolio optimisation engine may run a process using the current and a series of potential higher and lower prices (which may be defined by the user) to creates a host of scenarios of how flexible assets (like batteries or engines) should be run based on the current price and potential future prices if the price were to move. This is similar to an options contract whereby as prices move, volumetric position moves as well. The expected volumetric position of the option is called the delta and the derivative of the delta is called the gamma (i.e. gamma is the rate of change for an option’s delta based on a single-point move in the delta’s price). The effect of the optimisation scenarios on the net open position may be illustrated on top of the NOP position by way of the candlesticks 414 (which may also be referred to as gamma sticks).

In other words, when a portfolio contains assets that are flexible and can respond to price movements, the output of the asset may be dependent on either the market price, of if not discovered, the forecast of market price. For example, a portfolio may be balanced (with sales equal to generation) when the market price is £100/MWh. If the portfolio includes a gas engine that costs £110/MWh to run it will not be cost-effective to run this asset at the current market price and therefore the gas engine will be forecast to be off in this optimisation scenario. However, if the price were to move to £120/MWh then the trader would normally need to re-run the optimisation calculation and schedule the gas engine on. In which case, the net open position would change and the trader would have output to sell.

In another example, the market may be trading at £50/MWh and the trader may have 20 MW to buy. This would be denoted by a NOP of -20 MW. However, the trader may also have a gas engine with a 10 MW capacity that costs £52 to generate, and another, less efficient, gas engine that costs £54/MWh to generate. The NOP screen will show a 20 MW short position, with a coloured candlestick 414 having a red portion from -20 MW on the y-axis to -10 MW with a legend denoted as +£2/MWh. A second, yellow, portion of the coloured candlestick 414 will extend from -10 MW to 0 MW with a legend of +£4/MWh. From this insight the trader will quickly determine that if the current market price of £50/MWh moves slightly up (by < 10%) they should not buy power, instead they should consider running an optimisation and switching on their gas engines.

In some cases, optimisations may be calculated at the market price (or forecast), at slightly above the market price (or forecast) and at slightly below the market price (or forecast). This provides information on possible net open positions which are dependent on the market price and this information is plotted in the candlesticks 414 to illustrate the likely position of the portfolio should prices move up or down.

The candlesticks 414 in FIG. 6 indicate the net open position at two higher than market prices and two lower than market prices. More specifically, the green and white portions of the candlesticks 414 show how much longer the position would be if prices went up £5 and £10 /MWh, respectively. Similarly, the yellow and red portions of the candlesticks 414 show how much shorter the position would be if prices went down £5 and £10 /MWh, respectively. In some cases, only one higher and one lower price may be considered and in other cases, more than two higher or lower prices may be considered and illustrated in the candlesticks 414.

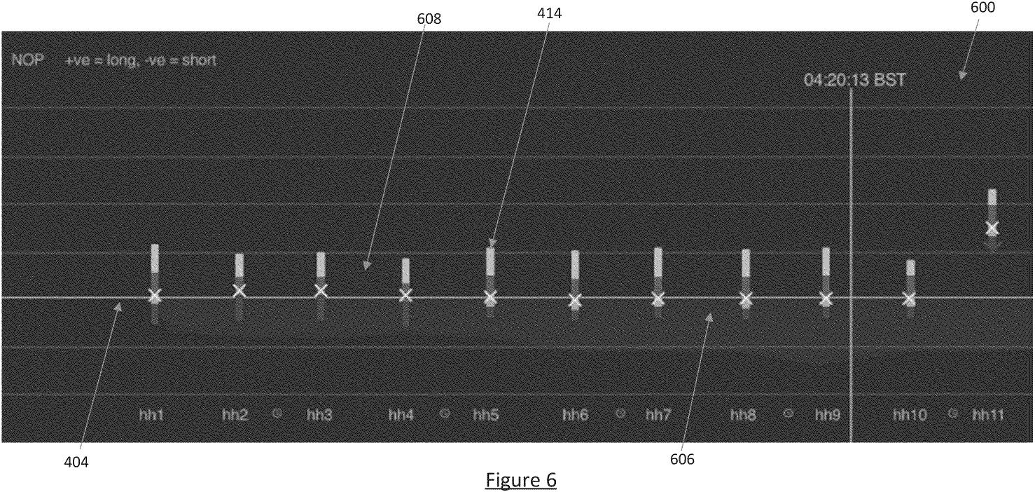

In some examples, the system may be configured such that a user may click on a candlestick 414 to obtain further information regarding price movement. For example, a graph 700 of intraday price movement may be presented as shown in FIG. 7. The graph 700 includes a yellow line 702 representing the previous prices used to run the most recent optimisation and a green line 704 representing the latest price forecast. The trader can therefore use the graph 700 to determine whether the market price has gone up or down since the last optimisation and hence determine how the position will change.

It will be understood that the candlesticks 414 described herein enable a trader to visualise the optionality of their net open position, quickly. By including the candlesticks 414 around the net open position, it is possible to overlay the optionality of the portfolio so it can be viewed in conjunction with the intermittent balancing zones described above, without the need to stack different screens or graphs with these two different sources of positon variance.

Furthermore, the trader does not need to wait for an optimisation to be run in order to consider different pricing scenarios on the net open position as this information is readily available through the provision of the candlesticks 414.

Accordingly, with the present methods it possible to view a combination of the intermittent balancing zone, net open position and gamma sticks to allow for simultaneous understanding of the net open position, uncertainty and optionality.

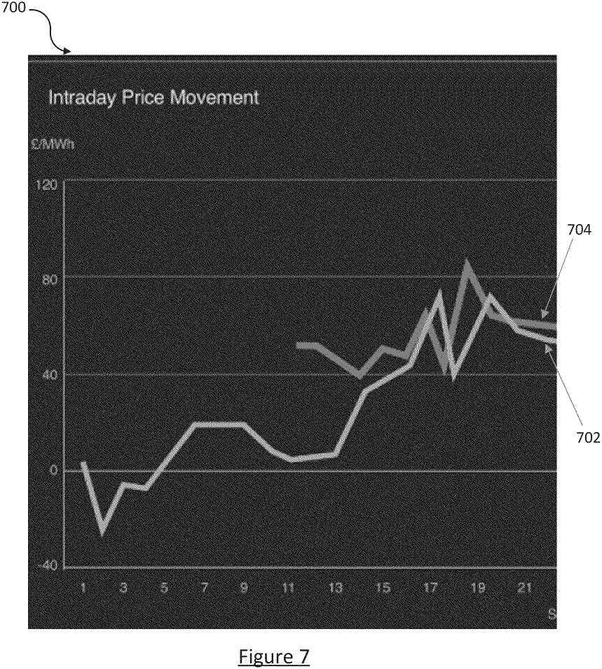

FIG. 8 shows a computer-implemented method 800 for visualising when to trade for a portfolio of intermittent assets in an energy market, in accordance with an embodiment. The method 800 comprises a step 802 of determining a net open position based on a difference between forecasted energy generation and forecasted energy sales for the portfolio for one or more time periods; a step 804 of determining a direction of trade indicating whether buying or selling is required to balance the net open position; a step 806 of obtaining a forecast price direction for the buying or selling based on current market analysis; a step 808 of determining a timing recommendation for the buying or selling, based on the direction of trade and the forecast price direction; and a step 810 of generating a position screen comprising a plot indicating the net open position, the direction of trade and the timing recommendation.

The method 800 uses information on price direction, which may be obtained from an internal or external source (e.g. by comparing the current market price with the forecast market price for the next trading period), as well as the direction to close the net open position (e.g. buying or selling) to determine whether the trader should close the net open position quickly. For example if prices are forecast to be lower later and the trader needs to buy, the method 800 will indicate both the direction needed to trade (e.g. up for buying; down for selling) and the need for urgency in the form of the timing recommendation (e.g. red wait; green trade), so, in this case, the method 800 will indicate an upwards red arrow (signalising a recommendation to wait to buy).

Just like with gamma sticks, the basis insight provided by the present method 800 gives the trader a price view but on a volumetric chart.

Short-term power trading often involves realising arbitrages between different markets. The method 800 can use a differential between the current market and the next (Intra-day versus imbalance or day ahead versus intra-day forecast) to determine the forecast market movement. The method 800 may then assess the net open position and overlay a basis position.

In an example, a trader may have a 10 MW short position (i.e. they need to buy 10 MW to become balanced). The traded price on the exchange may be £100/MWh. However, the cost of being out of balance (i.e. what the trader would have to pay the operator of the system) may be forecast at £80/MWh. In this example, the trader might want to take advantage of the basis (price over time) difference between the continuous market with a firm known price now or a forecast cheaper administered imbalance price. Accordingly, the trader may choose the certainty of a fixed £100/MWh now as opposed to a forecast £80/MWh. In other examples, however, the trader may choose the forecast price over the current fixed price.

In summary, the basis insight of the method 800 uses the direction of the position (energy to sell or energy to buy) combined with the forecast price direction (going to get cheaper / going to get more expensive) to recommend the best trading action, as summarised in Table 1 below.

TABLE 1

Timing Recommendation on the basis of price direction

| | | |
|---|---|---|
| | Price Rising | Price Falling |
| Buying / Short postion (arrow upwards) | Buy now (green) | Buy later and buy at a lower price (red) |
| Selling / Long position (arrow downwards) | Sell later and sell at a higher price (red) | Sell now (green) |

Accordingly, the method 800 may determine a timing recommendation to trade now when either: the direction of trade is to buy and the forecast price direction is rising; or the direction of trade is to sell and the forecast price direction is falling. Conversely, the method 800 may determine a timing recommendation to wait when either: the direction of trade is to buy and the forecast price direction is falling; or the direction of trade is to sell and the forecast price direction is rising.

The method 800 therefore uses knowledge of the position direction, the current market price and an input forecast of a future market price to determine the trading action. The trader is then presented with a coloured arrow representing the direction of the trade (up = buy and down = sell) and the timing recommendation (green = trade now and red = wait).

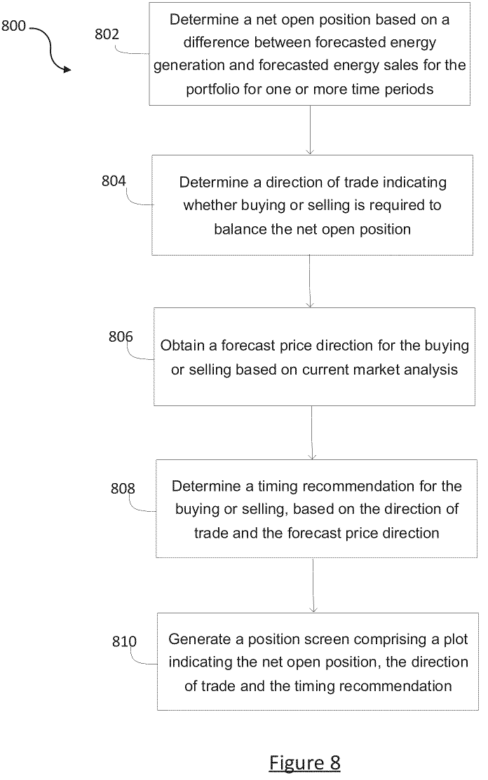

FIG. 9 shows an enlarged portion of the screenshot of FIG. 6, showing an example of a candlestick 414 and a positive basis insight arrow 900, in accordance with an embodiment. The arrow 900 is directed upwards and provided at an upper end of the candlestick 414 to indicate the need to buy to close the net open position x and is green to indicate a recommendation to trade now (indicating that the price is forecast to rise).

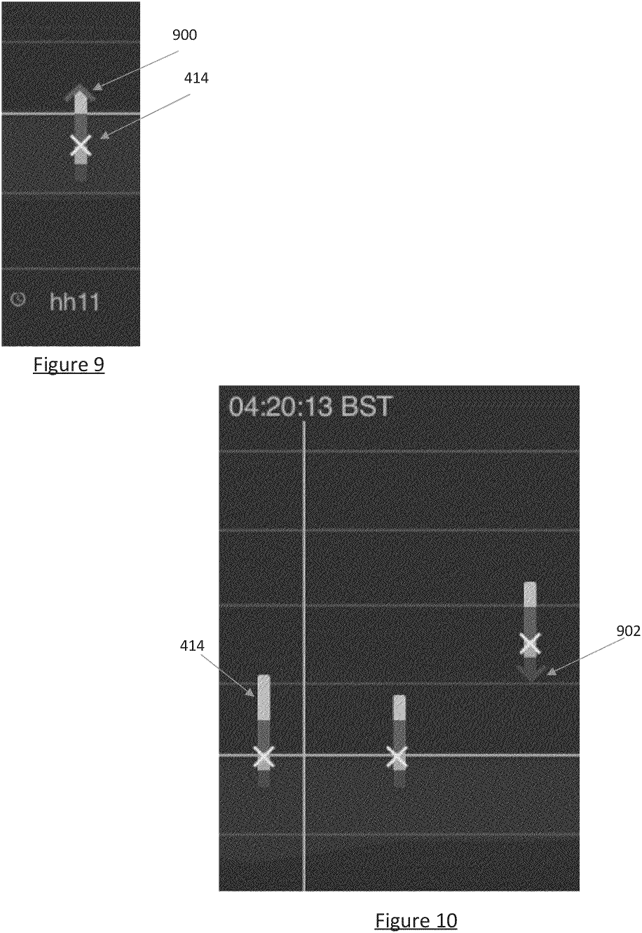

FIG. 10 shows an enlarged portion of the screenshot of FIG. 4A, showing three candlesticks 414 and a negative basis insight arrow 902, in accordance with an embodiment. The arrow 902 is directed downwards and provided at a lower end of the candlestick 414 to indicate the need to sell to close the net open position x and is red to indicate a recommendation to trade later (indicating that the price is forecast to fall). Notably, the basis insight arrow 902 is only provided on the candlestick 414 around a future net open position x, where action is required to close the position.

According, the method 800 can be used to overlay additional information, providing basis insight, on the net open position screen. As such, a single chart can be used to provide information on volumetric net open position and price basis insight, quickly and effectively.

Short term energy trading requires that decisions are made on forecasts of demand, forecasts of generation from intermittent sources, asset availability and running costs, market prices, and market price movement versus adjacent markets. The methods described herein relating to display of net open position with intermittent balancing zones, gamma sticks and basis insight so that all of this information can be conveyed in one overlapping volumetric and commercial graph. Traders can then make instant decisions without looking to three different sources of information.

Whilst, each of the methods 200, 500 and 800 are advantageous in their own right, the combination of any two or more of these methods adds even greater value. For example, by adding information relating to intermittency (price independent) and optionality (price dependent) and price direction into the same graph, allows the trader to interpret variance, gamma and basis simultaneously. Conveniently, the intermittency is illustrated by placing a zone (reversed in direction) around the x-axis, the optionality is illustrated using a candlestick and the trading insight is illustrated using a coloured arrow, leading to three times the normal trade information being determined and displayed in a single chart. This results in a faster and more complete transfer of information to the trader, which in turn allow trades to be executed more quickly and accurately.

The methods described are particularly suitable for use in a user interface for a trader decision platform for short-term power trading, where the opportunity to trade quickly can be hugely beneficial. One or more of the methods may be used for other fast moving decision-making applications where basis risk and/or random uncertainty and/or optionality are present. As such, aspect of the invention may be suitable for use in applications relating to gas market trading or transmission rights trading.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Furthermore, features described in relation to one embodiment may be mixed and matched with features from one or more other embodiments, within the scope of the claims.

1. A computer-implemented method for visualising intermittency in a trading position for a portfolio of intermittent assets in an energy market, the method comprising;
determining a net open position based on a difference between forecasted energy generation and forecasted energy sales for the portfolio for one or more time periods;
determining a target position to bring the net open position to zero based on a target degree of confidence in at least the forecasted energy generation;
determining a higher position to bring the net open position to zero based on a higher degree of confidence in at least the forecasted energy generation;
determining a lower position to bring the net open position to zero based on a lower degree of confidence in at least the forecasted energy generation;
generating a position screen comprising a plot for said one or more time periods, wherein the target position forms an axis of the plot, a first zone is indicated between the axis and the higher position and a second zone is indicated between the axis and the lower position; and indicating on the plot, the net open position.

2. The method of claim 1 wherein the first zone is indicated on a first side of the axis and the second zone is indicated on a second side of the axis.

3. The method of claim 1 wherein the axis is a horizontal x-axis, the first zone is indicated in a negative domain of a vertical y-axis and the second zone is indicated in a positive domain of the vertical y-axis.

4. The method of claim 1 wherein the forecasted energy generation for the portfolio comprises a sum of a forecasted energy generation for each intermittent asset including a variance in each forecast.

5. The method of claim 1 wherein the forecasted energy generation for the portfolio takes into account a correlation of at least one asset to at least one other asset in the portfolio.

6. The method of claim 1 wherein the target degree of confidence is calculated as a median output prediction, the higher degree of confidence is calculated as at a higher than median confidence level, and the lower degree of confidence is calculated at a lower than median confidence level.

7. The method of claim 1 further comprising tracking outturn output for the portfolio and comparing the outturn output with the forecasted energy generation.

8. The method of claim 7 further comprising determining whether any trends in variation between the outturn output and the forecasted energy generation indicate that the target position should be based on a different confidence level.

9. The method of claim 1 further comprising requesting user input for one or more of: the target degree of confidence; the higher degree of confidence; and the lower degree of confidence.

10. A computer-implemented method for visualising optionality in a trading position for a portfolio of flexible assets in an energy market, the method comprising;
determining a net open position based on a difference between forecasted energy generation and forecasted energy sales for the portfolio for one or more time periods;
determining at least one longer net open position based on at least one increased price variance;
determining at least one shorter net open position based on at least one decreased price variance; and
generating a position screen comprising a plot indicating the net open position, the at least one shorter net open position and the at least one longer net open position.

11. The method of claim 10 wherein the at least one shorter net open position and the at least one longer net open position are illustrated by a stick length about the net open position.

12. The method of claim 10 comprising:
determining at least two longer net open positions based on at least two increased price variances;
determining at least two shorter net open positions based on at least two decreased price variances; and
indicating on the plot the at least two shorter net open positions and the at least two longer net open positions.

13. The method of claim 12 wherein the at least two shorter net open positions are illustrated by at least two different coloured stick lengths extending from the net open position in a first direction; and the at least two longer net open positions are illustrated by at least two different coloured stick lengths extending from the net open position in a second direction.

14. A computer-implemented method for visualising when to trade for a portfolio of intermittent assets in an energy market, the method comprising:
determining a net open position based on a difference between forecasted energy generation and forecasted energy sales for the portfolio for one or more time periods;
determining a direction of trade indicating whether buying or selling is required to balance the net open position;
obtaining a forecast price direction for the buying or selling based on current market analysis;
determining a timing recommendation for the buying or selling, based on the direction of trade and the forecast price direction; and
generating a position screen comprising a plot indicating the net open position, the direction of trade and the timing recommendation.

15. The method of claim 14 wherein the direction of trade is indicated by an arrow and the timing recommendation is indicated by a colour of the arrow.

16. The method of claim 14 wherein the timing recommendation comprises an indication to trade now or an indication to wait.

17. The method of claim 16 wherein determining the timing recommendation comprises:
determining to trade now when either:
the direction of trade is to buy and the forecast price direction is rising; or
the direction of trade is to sell and the forecast price direction is falling; and
determining to wait when either:
the direction of trade is to buy and the forecast price direction is falling; or
the direction of trade is to sell and the forecast price direction is rising.

18. The method of claim 1 further comprising at least one of:
determining a net open position based on a difference between forecasted energy generation and forecasted energy sales for the portfolio for one or more time periods;
determining at least one longer net open position based on at least one increased price variance;
determining at least one shorter net open position based on at least one decreased price variance; and
generating a position screen comprising a plot indicating the net open position, the at least one shorter net open position and the at least one longer net open position; or
determining a net open position based on a difference between forecasted energy generation and forecasted energy sales for the portfolio for one or more time periods;
determining a direction of trade indicating whether buying or selling is required to balance the net open position;
obtaining a forecast price direction for the buying or selling based on current market analysis;
determining a timing recommendation for the buying or selling, based on the direction of trade and the forecast price direction; and
generating a position screen comprising a plot indicating the net open position, the direction of trade and the timing recommendation.

19. The method of claim 10 further comprising:
determining a net open position based on a difference between forecasted energy generation and forecasted energy sales for the portfolio for one or more time periods;
determining a direction of trade indicating whether buying or selling is required to balance the net open position;
obtaining a forecast price direction for the buying or selling based on current market analysis;
determining a timing recommendation for the buying or selling, based on the direction of trade and the forecast price direction; and
generating a position screen comprising a plot indicating the net open position, the direction of trade and the timing recommendation.

20. A non-transitory computer readable medium comprising instructions for carrying out the method of claim 1.
